(19) United States
(12) Patent Application Publication
(10) Pub. No.: US 2016/0131067 A1
(43) Pub. Date: May 12, 2016

(54) Automated Assembly of ECU Calibrations

(71) Applicant: INTERNATIONAL ENGINE INTELLECTUAL PROPERTY COMPANY, LLC, Lisle, IL (US)

(72) Inventor: Peter Jon Romba, Saint Charles, IL (US)

(73) Assignee: International Engine Intellectual Property Company, LLC, Lisle, IL (US)

(21) Appl. No.: 14/893,566

(22) PCT Filed: May 29, 2013
(86) PCT No.: PCT/US13/42964

§ 371 Date: Nov. 24, 2015

(51) Int. Cl. F02D 41/24; F02D 41/28; F02D 41/26

(52) U.S. Cl. CPC F02D 41/2432; F02D 41/26; F02D 41/28

(57) ABSTRACT

A system and method for building engine calibrations for the operation of an engine. The system includes a processor that is operatively coupled to a memory. The system identifies a plurality of features, which may be stored on a memory, relating to the operation of the engine. Each of the plurality of features is associated with a feature calibration data file. A user may selected, such as via operation of an input, which features are to be used in building engine calibrations. The system may implement rules that identify which of the selected features may be combined with other selected features in creating the engine calibration build. The feature calibration files for permissible combinations of features may then be assembled and used in generating an engine calibration.

### BACKGROUND

Many modern vehicles utilize computer-controlled engines. These computers are typically special-purpose embedded hardware, and are often referred to as Engine Control Units (ECUs) or Engine Control Modules (ECMs). These modules command and regulate the core operation of the engine, including fuel injection and ignition timing. The ECU's software is typically configured, or calibrated, to achieve desired operational or optimized performance of the vehicle and/or engine. Such engine calibration may be based on a variety of features relating to operation and/or performance of the engine, including, but not limited to, the volumetric displacement of the engine, the number of engine cylinders, emissions and diagnostic compliance, horsepower rating, injection type, and the type of transmission, among others, as well as specific settings within each of those features. Further, in building an engine calibration that is based on a collection of calibrations of particular features, the calibration of a first feature may influence the calibration of a second feature, both of which may influence the calibration of a third feature, all of which may influence the calibration of a fourth feature, and so on. Thus, the calibration of one feature, or changes/adjustment in that calibration, may have a far reaching ripple effect that may influence numerous other calibrations for other features.

Manufacturers and designers of vehicles and/or engines, such as internal combustion engines, may have various teams of employees that are responsible for developing and/or determining calibrations for specific features and/or groups of features. Typically, when a team determines, or makes an adjustment, to a feature calibration, that calibration may be collected in an electronic data file and aggregated with other data files using industry-standard tools to assemble into a complete engine calibration. For example, ETAS GmBH provides software products under the family name INCA that includes products software used to calibrate engines. When a feature calibration is determined or adjusted and INCA software is being used to calibrate the engines, a DCM formatted electronic data file associated with the feature(s) calibration(s) may be provided to a depository, collector, or build engineer, among others, such as, for example through the use of a central calibration data management system.

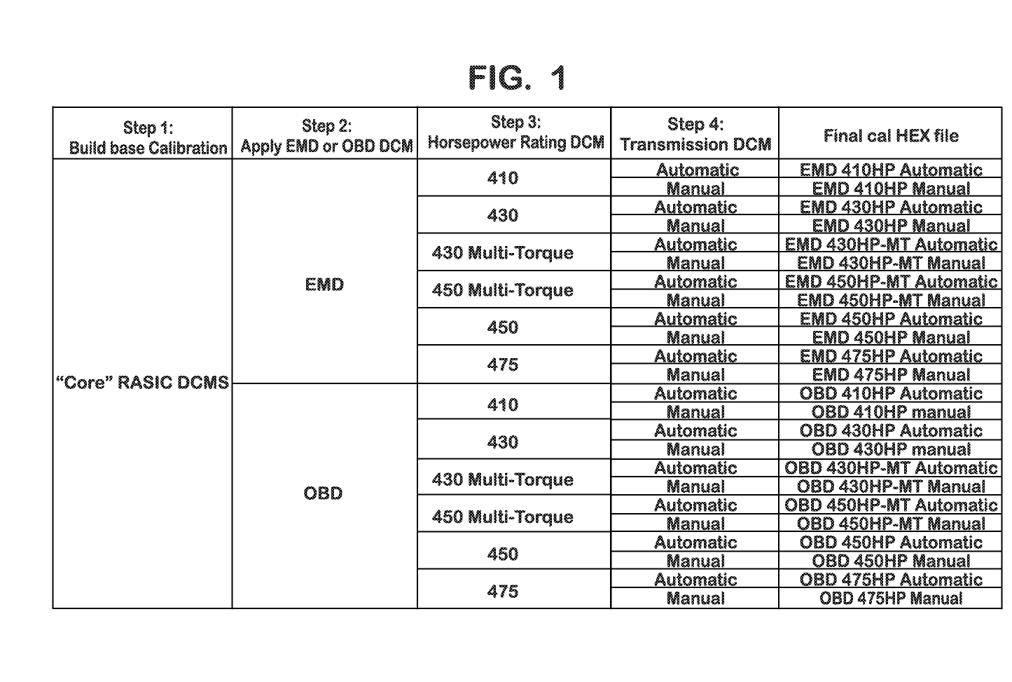

The feature calibration file may then be integrated into the control software. In at least some instances, particular feature calibrations, such each engine displacement, horsepower, and transmission combination, require a unique combination of DCM electronic data files. For purposes of illustration and simplicity, FIG. 1 provides an example of how various parameter calibrations may be assembled into an engine calibration, such as, for example, by a build engineer. In this example, as step 1, the build engineer may obtain feature calibrations, and such as DCM files representing particular feature calibrations, from the various teams responsible for providing the feature calibrations. At step 2, a feature, and thus the associated DCM calibration data file, is selected, such as, for example, the selection of the type of self-diagnostic and reporting capability used by the vehicle/engine, such as on-board diagnostics (OBD) or engine manufacturer diagnostics (EMD). At step 3, another parameter, and the associated DCM calibration data file, may be selected, such as the horsepower rating corresponding to either the OBD or EDM selected at step 2. At step 4, another parameter, and the associated DCM calibration data file, is selected, such as the transmission type (manual or automatic) for the particular diagnostics and horsepower features selected at steps 2-3. The DCM data files assembled in steps 1-4 may then become part of a final engine calibration file, such as, for example, a HEX formatted file.

Manual assembly of an engine calibration, such as that illustrated in FIG. 1, is typically relatively extremely labor intensive. For example, with INCA software, a build engineer may need to click and copy a DCM file, paste the DCM file into a final engine calibration file, and wait for the DCM file to actually be copied before repeating the process for the next feature, with this process continuing until the build is complete. Moreover, for example, a commercially available diesel powered heavy-duty engine platform may have over 30,000 calibratable parameters that the builder has to select from when creating an engine calibration for a particular engine. Such manual building of a calibration may take around 8-12 hours, which may result in fewer engine calibration builds, as well increase the opportunities for user mistakes. Additionally, subsequent changes in calibrations may require repeating prior steps, and thereby have the repeat potential for user error.

### BRIEF SUMMARY

According to certain embodiments, a system is provided for building engine calibrations for the operation of an engine. The system includes a processor that is operatively coupled to a memory. The processor is configured to identify a plurality of features relating to the operation of the engine. Further, each of the plurality of features has a feature calibration data file. The processor is also configured to receive an identification of a plurality of selected features that are selected from the identified plurality of features. Additionally, the processor is also configured to implement rules to identify allowable combinations the plurality of selected features. At least some of the plurality of features are allowed to be combined with at least some other features of the plurality of features. The processor is also configured to assemble at least the feature calibration data files for the allowable combinations of features from the selected features and build the engine calibrations using at least the assembled feature calibration data files.

Additionally, certain embodiments provide a system for building an engine calibration for the operation of an engine. The system includes a processor that is operatively coupled to a memory and an input. The processor is configured to display on a display a plurality of features, each of the plurality of features being associated with a feature calibration data file. The processor is also configured to receive instructions from the input identifying from the plurality of features a plurality of selected features. Additionally, the processor is configured to identify which of the plurality of selected features may be combined together to provide a plurality of combined features. Moreover, at least some of the plurality of features not being combinable with at least some other features of the plurality of features. The processor is also configured to assemble the feature calibration data files for the plurality of combined features to provide at least a portion of the engine calibration.

Further, according to certain embodiments, a method is provided for building an engine calibration for the operation of an engine. The method includes displaying, on a display, a plurality of features relating to the operation of the engine, with each of the plurality of features being assigned a feature calibration data file. The method also includes selecting, by operation of an input, from the plurality of features a plurality of selected features. The processor implements rules governing which of the selected features are allowed to be combined together. Further, at least a portion of the features of the plurality of features are not allowed to be combined with at least some other features of the plurality of features. The method also includes assembling the feature calibration data files of at least a portion of the allowed combinations of selected features to build at least a portion of the engine calibration.

BRIEF DESCRIPTION OF SEVERAL VIEWS OF THE DRAWINGS

FIG. 1 is a table illustrating at least a portion of the steps involved in building the calibrations used by an ECU.

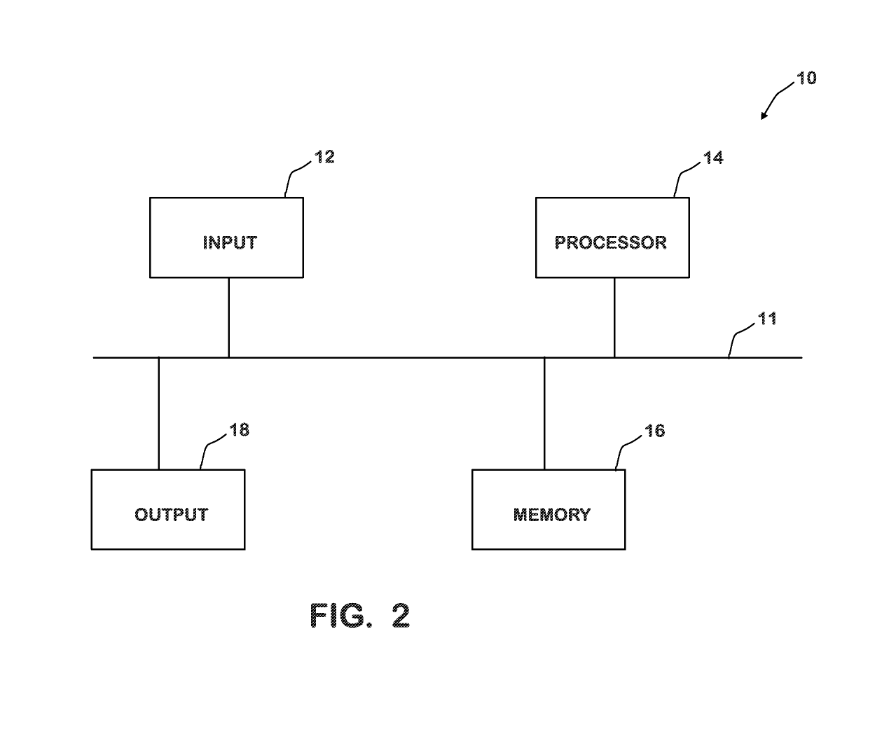

FIG. 2 illustrates a schematic of a system for use in building a calibration for a vehicle or engine.

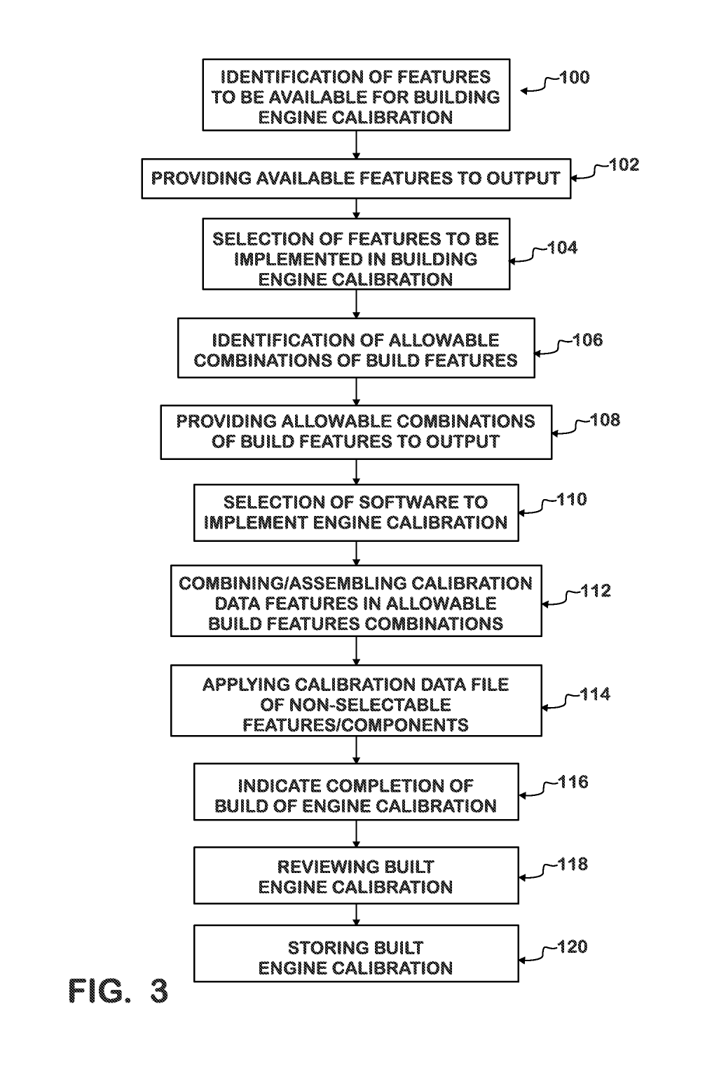

FIG. 3 illustrates a flow chart for an implementation that builds a calibration for a vehicle or engine using a software program.

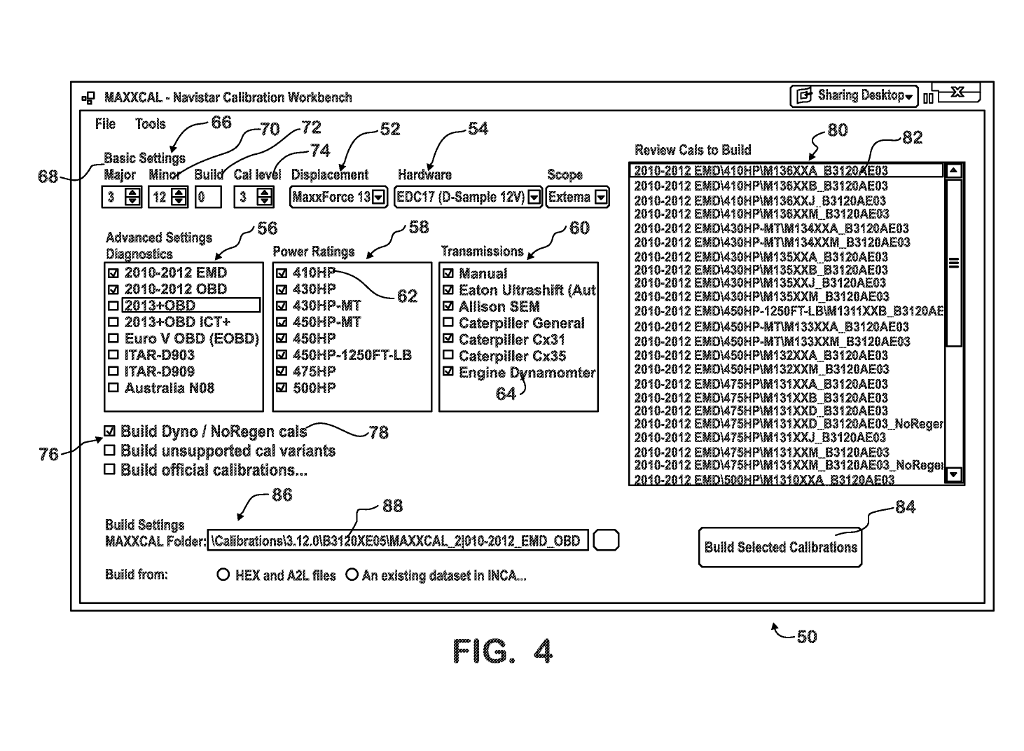

FIG. 4 provides an example of a graphical user interface that may be displayed by the output and used in selecting features for building engine calibrations.

### DETAILED DESCRIPTION

FIG. 2 illustrates a schematic of a system 10 for use in building a calibration for a vehicle or engine. The system 10 includes an input 12 for allowing the user or other systems or devices to input or transfer information into the system 10. For example, the input 12 may be a keyboard, sensor, graphical interface, computer mouse, or scanner, among other devices that may provide information to the system 10 and/or select information that is already in the system 10. Information, instructions, or other data may be communicated in the system 10 through the use of a bus 11. For example, information inputted or selected the through use of the input 12 may be transferred to a processor 14 or other component of the system 10 via the bus 11.

The system 10 may also include a memory 16, which may or may not be part of the processor 14. The memory 16 may store programing, instructions, or other information that is used or executed by the processor 12. For example, the memory 16 may store data relating to feature calibrations, as well as rules associated with which particular features may, or may not, be used with other features. According to certain embodiments, the memory 16 may be a non-transitory computer-readable storage medium. Suitable memories 16 include, but are not limited to, permanent memory, RAM, ROM, or a hard drive, among others. The system 10 may also include an output 18, such as, for example, a monitor or display that a user may read, and/or a port or cable that may be used in the delivery of information from the system 10 to another system, device, machine, or other non-transitory computer-readable storage medium.

FIG. 3 illustrates a flow chart for an implementation that builds a calibration for a vehicle or engine using a software program. According to certain embodiments, the implementation may be a computer or software application(s) or program(s) written in C Sharp (C#) utilizing a developer application programming interface (API), such as, for example, the API offered by INCA from ETAS GmBH. Additionally, according to certain embodiments, the implementation may be provided by a load and/or read data file, such as, for example an XML file. Further, according to certain embodiments, the implementation may be programming that is that is stored or copied to the memory 16 and executed by the processor 14.

At step 100, the implementation identifies the features that are to be available for building the engine calibration. According to certain embodiments, a build tree is utilized by the implementation for the selection of features for use in building the engine calibration. The build tree may be a data file that contains information regarding the features. Further, the build tree may be used to determine which features a user of the implementation may select to be part of the engine calibration. These selectable features may be subcomponents of categories of features. Examples of categories of features may include, but are not limited to, engine trims, diagnostic levels, horsepower ratings, and transmission types, among others. Additionally, the build tree may specify the file paths or locations where the data files, such as DCM files, that contain the calibration data for particular feature, are stored on the memory 16 or other device that is operably connected to the system 10.

For example, according to certain embodiments, the data file may include software code that identifies each feature by particular attributes and/or characterizations of that feature. For example, for a feature of an engine power rating of 330 horsepower, the software code may include a title for the feature that may or may not reflect the particular feature, such as, for example, the title “330 HP.” According to certain embodiments, the software code may also identify a character code for the particular feature. The character code may be combined with the character codes of other features to provide a calibration identification code reflecting the various features that have been used or combined to assemble a particular engine calibration. For example, the calibration identification code may be represented by the alphanumeric code 1234-xx-5678, where the digits or “34” are a character code that identifies the feature of a power rating of 330 horsepower engine being part of the engine calibration, while other characters in the calibration identification code correlate to other features, such as “12” identifying a particular engine displacement feature, “xx” identifying a particular transmission, and “56” and “78” identifying to other features that are part of the engine calibration.

The data file corresponding to the build tree may also include rules for the combination of a selected feature with features from one or more other groups of features. For example, the software code, which may be written in C#, Visual Basic, PHP, or Java, among others, for the previously discussed feature of “330 HP” may include in its associated code one or more “restriction” commands that identify which other features from different categories of features the “330 HP” feature may not be combined with, such as “forbidden” commands, and/or which identifies the only other features that may be used in a combination with the “330 HP” feature, such as “allow” commands. For example, the code may indicate which particular transmissions from the category of transmissions the “330 HP” feature from the category of power ratings may, or may not, be used with in assembling the engine calibration.

At step 102, the categories of features and/or features within the categories available for selection may be provided. For example, FIG. 4 provides an example of a graphical user interface 50 that may be displayed by the output 18, such as on a monitor, that displays at least a portion of the available categories of features and/or features. More specifically, the exemplary graphical user interface 50 illustrates features, grouped by categories of features, which may be selected for building the engine calibration. For example, according to the illustrated embodiment, a particular feature from the categories of engine platform or displacement 52, hardware level 54, type of diagnostics 56, engine power rating 58, and transmission type 60, among others, may be selected for the building of an engine calibration.

At step 104, features for building the engine calibration may be selected. For example, as shown in FIG. 4, the graphical user interface 50 may include check boxes next to available features that a user may select through operation of the input 12, such as, for example, by the clicking of a computer mouse, touching a touch screen monitor, and/or operation of a keyboard, among others. The graphical user interface 50 may also include pull-down menus or allow other selection or entry options that allow for the selection or identification of features for building the engine calibration. Further, according to certain embodiments, the selection or specification of a particular feature within a category of features, such as, for example, selecting the feature 62 of “410 HP” in power ratings category 58, may alter features displayed and/or selectable in other categories, such as, for example, the feature 64 “Engine Dynamometer” not being displayed and/or changing from a feature that may have the associated check box change from being able to be selected by placing a check in the box to being un-selectable by not accepting a check in the check box.

Further, according to certain embodiments, the user may be permitted to select one or more than one feature in one or more of the categories. For example, as shown in FIG. 4, the user may select each feature listed in the “Power Ratings” category 58, such as 410 HP, 430 HP, 430 HP-MT, etc.

Additionally, according to certain embodiments, at step 104 the user may select or input additional criteria to apply to the selected features, the assembly of the features, and/or options that aid in the identification or distinction of the engine calibration that is being built. For example, according to certain embodiments, the user may identify “Basic Settings” 66 to be applied to the selection and/or assembly of the features. For example, the user may set “Major” and “Minor” options 68, 70 to identify the version of the decision tree and/or the implementation that is to be used in building the engine calibration. The user may also assign the build a particular identification, such as inputting an alphanumeric identifier into a “Build” option 72. Further, as calibrations for features, and rules associated with those calibrations, change over time, the user may provide an indication of the particular version of the feature calibrations to be used in building the engine calibration by selecting a “Cal level” option 74.

The user may also be permitted to provide additional instructions 76 for building the engine calibration beyond the selection of particular features. For example, in the illustrated embodiment, the user may be given the option of having engine calibrations built for engines that may be used in a dynamometer with a modified or removed exhaust gas treatment system (“Build Dyno/NoRegen cals” option 78). Such optional selections may introduce rules in addition to those identified by the decision tree into the building of the engine calibration, such as, for example, limit calibration builds to the highest permitted horsepower in the “Power Ratings” category 58 for the engine platform selected in the “Displacement” category 52.

At step 106, features selected by the user at step 104 may be combined pursuant to the rules identified in the decision tree to identify allowable combinations of features and/or the permissible engine calibrations for those combined features. At step 108, these permissible combinations may be provided to the output 18, such as, for example, being displayed in a window 80 on the graphical user interface 50. According to certain embodiments, the identification of permissible combinations may commence upon a command or instruction by the user, such as, for example, the user using a computer mouse or touch screen monitor and clicking, touching, or otherwise selecting the appropriate button or icon on the graphical user interface 50, or through other operation of the input 12. Alternatively, according to other embodiments, the permissible combinations may begin appearing and/or disappearing in the window 80 as features are selected, with the permissible engine calibrations displayed in the window 80 being added, changed, and/or removed changing as features are added or removed.

FIG. 4 provides an example listing of each permissible combination, pursuant to at least the rules in the decision tree or any other rule, based on the features selected by the user at step 104. For example, the first engine calibration 82 illustrated in the window 80 is “2010-2012 EMD \410HP\M136XXA_B3120AE03” with (1) “2010-2012 EMD” corresponding to a selected feature from the “Diagnostic” category 56 of features; (2) “410 HP” corresponding to a selected feature 62 in the “Power Rating” category 58; (3) and “M136XXA_B3120AE03” being the calibration identification code associated with selected and/or non-selected features.

According to certain embodiments, at step 110, the user may select the software that will be used to implement the engine calibration, such as, for example, the software used to run the engine calibration on the engine control unit. The selected software may thus determine the format in which the data corresponding to the particular feature calibrations being used in the engine calibration are to be arranged or otherwise presented or formatted for use by the selected software.

At step 112, the engine calibration file may being to be built by combining and/or assembling the calibration data files, such as the DCM files, associated with each selected feature that is part of the permitted engine calibration. According to certain embodiments, this building of the engine calibration(s) data file(s) may be automatic, such as, for example after the identification of user-selected features for the engine calibration and/or the identification of the permissible calibration(s) that is/are to have engine calibrations built. Alternatively, the one or more possible engine calibrations displayed in the window 80 may being to be built upon the instruction or command of the user, such as, for example, the user using the input 12 to select a “Build Selected Calibrations” icon or button on the graphical user interface 50 and/or selecting one or more particular possible engine calibrations for calibration building.

According to certain embodiments, before automatic building of the engine calibration(s) commence, the user may be required to identify the location, such as the file path, of where the feature calibration data files, such as DCM files, are stored in the memory 16 or in another operably connected device or computer readable storage medium. For example, as shown in FIG. 4, the graphical user interface 50 may include a path identifier option 86 that allows the user to input or otherwise identify the path or location of a folder(s) 88 and/or subfolder(s) that contain the feature calibration data files for the one or more of the selected features. Such identification of the location of the data files to be used in the engine built may allow for the option of building different engine calibrations using different versions of feature calibration data files, or DCM files, such as when one or more feature calibration data, or DCM, files have been updated or otherwise altered. According to such an embodiment, once the location of the feature calibrations data files have been identified, the implementation may recursively comb the identified location and/or the associated folder(s)/subfolder(s) to obtain the calibration data files for each selected feature and proceed with assembling the engine calibration.

At step 114, the implementation may selectively apply calibration data files related to features or components of the engine or vehicle that were not eligible for selection by the user and/or are part of a category of features for which no selection was made. For example, the engine calibration may include standard feature calibrations that are not adjustable by a user, and are therefore automatically added to the engine calibration. Additionally, according to certain embodiments, in the event at least one feature in a category of selectable features has not been selected, a default feature within that category, and the associated data file, may be selected by the implementation for use in the building of the engine calibration. This default selection may be based on the rules of the decision tree as to which features from the unselected category of features may be used with the features from other categories that were selected for the engine build.

At step 116, according to certain embodiments, once the engine calibration(s) has been built, the implementation may indicate completion of the build. Such an indication may be communicated via the output 18, such as, for example, by a communication or message that is displayed on the monitor. According to certain embodiments, the message or communication may also indicate the total lapsed time between the start of the build process at step 112 and the completion of the build.

According to certain embodiments, at step 118, the implementation may perform a check of the engine calibration(s) that has/have been built. This check may review the engine calibration build(s) for any potential errors in the build(s) and/or any information that is missing, incomplete, corrupt, or otherwise incorrect in the build(s).

At step 120, the engine calibration(s) that have been built may be stored on a non-transitory computer-readable storage medium. For example, the built engine calibration(s) may be stored in the memory 16. Additionally, the built engine calibration(s) may be recorded as a computer executable program(s) by storing the engine calibration on a non-transitory storage medium, such as, for example, on non-removable mass storage (e.g., hard disk, solid-state drive), removable storage (e.g., tape, optical disc, floppy disk) and/or cloud storage, among others.

1. A system for building engine calibrations for the operation of an engine, the system comprising:
a memory;
a processor operatively coupled to the memory, the processor being configured to:
identify a plurality of features relating to the operation of the engine, each of the plurality of features having a feature calibration data file;
receive an identification of a plurality of selected features that are selected from the identified plurality of features;
implement rules to identify allowable combinations of the plurality of selected features, at least some of the plurality of features not being allowed to be combined with at least some other features of the plurality of features;
assemble at least the feature calibration data files for the allowable combinations of features; and
build the engine calibrations using at least the assembled feature calibration data files.

2. The system of claim 1, wherein the plurality of features are assigned to one or more categories of features, and wherein the processor is configured to select at least one default feature for a category of features that does not contain one or more selected features.

3. The system of claim 1, wherein the processor is configured to control the displaying of the plurality of features on a display.

4. The system of claim 3, wherein the processor is further configured to provide an indication on the display of when the build of the engine calibrations is complete.

5. The system of claim 1, further including an input operatively coupled to the processor, the input configured to allow a user to select the plurality of selected features.

6. The system of claim 5, wherein the processor is further configured to assemble, with the feature calibration data files, one or more calibration data files for one or more non-selectable features.

7. A system for building an engine calibration for the operation of an engine, the system comprising:
a memory;
an input;
a processor operatively coupled to the memory and input, the processor being configured to:
display on a display a plurality of features, each of the plurality of features being associated with a feature calibration data file;
receive instructions from the input identifying from the plurality of features a plurality of selected features;
identify which of the plurality of selected features may be combined together to provide a plurality of combined features, at least some of the plurality of features not being combinable with at least some other features of the plurality of features; and
assemble the feature calibration data files for the plurality of combined features to provide at least a portion of the engine calibration.

8. The system of claim 7, wherein the processor is further configured to review the assembled feature calibration data files.

9. The system of claim 7, wherein the processor is further configured to receive an identification, through the input, of a software to be used to run the built engine calibration on an engine control unit.

10. The system of claim 7, wherein the plurality of features are assigned to one or more categories of features, and wherein the processor is configured to select at least one default feature for a category of features that does not contain one or more selected features.

11. A method for building an engine calibration for the operation of an engine, the system comprising:
displaying, on a display, a plurality of features relating to the operation of the engine, each of the plurality of features having a feature calibration data file;
selecting, by operation of an input, from the plurality of features a plurality of selected features;
implementing, by the processor, rules governing which of the selected features are allowed to be combined together, at least a portion of the plurality of features not being allowed to be combined with at least some other features of the plurality of features; and
assembling the feature calibration data files of at least a portion of the allowed combinations of selected features to build at least a portion of the engine calibration.

12. The method of claim 11, further including the step of displaying on the display the allowable combinations of selected features.

13. The method of claim 12, further including the selection, by operation of the input, at least one of the displayed allowable combinations of selected features to be used in the step of assembling the feature calibration data files.

14. The method of claim 13, further including the step of identifying, the use of the input, the location of the feature calibration data files.

15. The method of claim 10, further including the step of saving the engine calibration on a non-transitory computer-readable storage medium.
